(19) United States
(12) Patent Application Publication
(10) Pub. No.: US 2026/0363237 A1
(43) Pub. Date: Nov. 19, 2026

(54) SOLID TABLET SEMIOCHEMICAL DISPENSERS FOR MATING DISRUPTION AND MASS TRAPPING OF INSECTS

(71) Applicant: Dr. Markandeya GORANTLA, Telangana (IN)

(72) Inventors: Mukesh Kumar MUKUL, Telangana (IN); Radha Srikrishna MAGANTI, Telangana (IN); Vishal PATIL, Telangana (IN); Akshitha Reddy KAUKUTTLA, Telangana (IN)

(21) Appl. No.: 19/515,695

(22) PCT Filed: Aug. 27, 2024
(86) PCT No.: PCT/IN2024/051561

§ 371 Date: Mar. 2, 2026

(30) Foreign Application Priority Data
Aug. 28, 2023 (IN) 202341057697

(51) Int. Cl. A01N 25/12; A01P 7/04; A01P 19/00

(52) U.S. Cl. CPC A01N 25/12; A01P 7/04; A01P 19/00

(57) ABSTRACT

The present invention discloses sustained release solid formulations containing pheromones and method of preparing the same. More particularly, the invention discloses solid formulations of pheromones viz., mono-layered tablets, bi-layered tablets and mini tablets or polo type tablets which are capable of gradually releasing a pheromone substance suitable for insect pest control over a long period of time and can be easily placed/dispersed/distributed on soil of a farm field or can be sprayed on the plants by dissolving in suitable medium. The solid formulations disclosed herein are stable and can be stored up to two years under normal storage conditions.

### TECHNICAL FIELD

The present invention relates to sustained release solid formulations containing pheromones and method of preparing the same. More particularly, the invention relates to solid formulations of pheromones viz., tablets and mini tablets which are capable of gradually releasing a pheromone substance suitable for insect pest control over a long period of time and can be easily placed/dispersed/distributed on soil of a farm field or can be sprayed on the plants by dissolving in suitable medium. The formulations of the present invention can be stored up to two years under normal storage conditions.

### BACKGROUND AND PRIOR ART

Insect pests cause considerable financial losses in agriculture. According to the recent studies, the pheromones, which act at low concentrations disrupt the insects' reproductive cycle. As these pheromones are naturally occurring from the body of insects, their environmental impact is usually negligible. However, it is very difficult to provide pheromones over a sufficient amount of time to disrupt the reproductive cycle over the entire fertile period of the insect.

Consequently, there has been an increase in demand for controlled release pheromone formulations which are adapted to allow the pheromone substance to be released continuously and sustainably into air thereby encouraging mating disruption and thus reduces the damage to the crops. In this context, ample literature is available on the pheromone formulations.

U.S. Pat. No. 4,325,941A discloses solid formulations containing, as an active substance, a sex pheromone; as main vehicles, a carrier having absorbing properties and another carrier having adsorbing properties, and, furthermore, a wetting agent, a dispersant, a sticker, an ultraviolet (U.V.) stabilizer, an antioxidant and, optionally, a film-forming resin.

WO88003755 discloses a synthetic pheromone composition for use in the control of the codling moth (Cydia pomonella), in a crop or orchard, comprises: (1) trans, trans-8,10,dodecadien-1-ol, (2) at least one additional component selected from dodecanol and/or tetradecanol, and, optionally, (3) a carrier material such octanol.

WO2001026462 discloses a biodegradable device with a slow release of volatile products which attract insects. The device consists of a biodegradable material based on starches and thermoplastic polymers impregnated with pheromones and moulded in spiral or hook form.

EP3090631A1 discloses sustained release pheromone formulation comprising a pheromone contained in a porous clay material, characterised in that the clay material has a weight average particle size of less than 0.2 mm.

U.S. Pat. No. 9,936,683B2 discloses a sustained release pheromone formulation that is not very likely to fall off from a tree branch or other support, once it is attached and secured to such a support, and which is capable of being quickly attached to large to small branches. However, the sustained release pheromone formulation needs to attach to a tree or other support.

In view of the foregoing, the objective of the present invention is to provide a sustained release pheromone solid formulation that can be placed/dispersed easily on the soil thereby avoiding a step of securing to the tree branch or other support and further provides continued controlled release of the active over the entire fertile period of the insect.

### ABBREVIATIONS

AI—Active ingredient
Compritol: Glyceryl Behanate
Tween 20: Polyoxyethylene Sorbitan Monolaurate
Tween 80: Polyoxyethylene sorbitan monooleate
BHT: butylated hydroxytoluene
DCP: Dicalcium phosphate
Klucel: Hydroxy propyl cellulose (HPC)
Carbon Glucospheres,
Neusilin US2: Magnesium Aluminometasilicate,
SBA15/Syloid 244P: Mesoporous silica

### SUMMARY OF THE PRESENT INVENTION

In line with the above, the present invention provides sustained release pheromone solid formulation in the form of tablets or mini tablets that can be dispersed/distributed on the soil which provide continued controlled release of the active into the air over the entire fertile period of the insect.

Accordingly, the invention provides solid formulations of pheromones which comprises; a) a premix consisting of pheromone in an amount of 0.5 to 60% adsorbed onto an adsorbent ingredient selected from the group consisting of mesoporous material(s), matrix forming agent(s) or the combination of mesoporous material(s) and matrix forming agent(s); and b) extra-granular ingredients consisting of mesoporous material, emulsifying agent, binder and lubricant.

In yet another aspect, the solid formulations are selected from tablets and mini tablets.

In a further aspect, the tablets are designed as coated or uncoated tablets of Biconvex nature, Polo type tablets and Mini tablets which can be prepared by compressing on suitable tabletting machine.

According to another aspect, the present invention provides a solid pheromone formulation which are optionally coated with a coating material.

The tablet or mini tablet formulations of the present invention provides continued and sustained release of the active into the air over a period of 50 to 100 days or more.

### DETAILED DESCRIPTION OF THE INVENTION

The present invention provides sustained release pheromone solid formulation that can be dispersed/distributed on the soil which provide continued controlled release of the active into the air over the entire fertile period of the insect.

In yet another embodiment, the solid formulations are selected from tablets and mini tablets.

In a further aspect, the tablets are designed as coated or uncoated tablets of Biconvex nature, Polo type tablets and Mini tablets, which can be prepared by compressing on tabletting machine.

The solid formulations of pheromones viz., tablets and mini tablets are capable of gradually releasing a pheromone substance suitable for insect pest control over a long period of time and can be easily placed/dispersed/distributed on the soil of a farm field or can be sprayed on the plants by dissolving in suitable medium and can be stored up to two years under normal storage conditions. The tablet or mini tablet formulations of the present invention provides continued and controlled release of the active into the air over a period of 50 to 100 days or more.

Accordingly, the invention provides solid formulations of pheromones which comprises:
a) a premix consisting of pheromone in an amount of 0.5 to 60% adsorbed onto an adsorbent ingredient selected from the group consisting of mesoporous material(s), matrix forming agent(s) or the combination of mesoporous material(s) and matrix forming agent(s) in an amount of 1 to 50%; and
b) extra granular ingredients consisting of mesoporous material, emulsifying agent, binder and lubricant in an amount of 75 to 85%.

According to an embodiment, the solid formulations of the present invention comprises;
a) a premix consisting of pheromone in an amount of 0.5 to 60% adsorbed onto mesoporous material(s) in an amount of 1 to 50%; and
b) extra-granular ingredients consisting of mesoporous material, emulsifying agent, binder and lubricant in an amount of 75 to 85%.

According to another embodiment, the solid formulations of the present invention comprises;
a) a premix consisting of pheromone in an amount of 0.5 to 60% adsorbed onto the matrix forming agent in an amount of 1 to 50%; and
b) extra-granular ingredients consisting of mesoporous material, emulsifying agent, binder and lubricant in an amount of 75 to 85%.

According to yet another embodiment, the solid formulations of the present invention comprises;
a) a premix consisting of pheromone in an amount of 0.5 to 60% adsorbed onto the combination of matrix forming agent and mesoporous materials in an amount of 1 to 50%; and
b) extra-granular ingredients consisting of mesoporous material, emulsifying agent, binder and lubricant in an amount of 75 to 85%.

In yet another aspect, the pheromones that can be used in the formulations according to the present invention are selected from the group consisting of the active blend of (Z, Z)-7, 11-hexadecadien-1-yl acetate and (Z, E)-7, 11-hexadecadien-1-yl acetate; the active blend of Z 9-Tetradecenyl acetate, Z7-Dodecenyl acetate and Z11-Hexadecenyl acetate; the active blend of E-11-hexadecen-1-yl acetate and (E)-11-hexadecen-1-ol; the active blend of 3E,8Z,11Z-Tetradecatrienyl acetate and 3E,8Z-Tetradecadienyl acetate; the active, (Z,Z,E)-7,11,13-Hexadeca trien-1-al; the active blend of Z-11-Hexadecenal, Z-11-Hexadecenyl-1-acetate and Z-11-Hexadecenol; the active blend of Z-11-Hexadecenal and Z-9-Hexadecenal; the active blend of Z-11-Hexadecenal and Z-9-Hexadecenal; the active blend of (Z,E)-9,11-Tetradecadienyl acetate and Z9,E-12-Tetradecadienyl acetate; the active blend of Cis-3-Hexenyl acetate and 2E-Hexen-1-ol; the active blend of Z-11-Hexadecenyl-1-acetate and Z-11-Hexadecenol; the active of Z-11-Hexadecenol; the active of (7Z,9E)-Dodeca-7,9,11-trien-1-yl formate (Carob moth); 11Z,13Z-Hexadeca dienal; the active blend of 4 methyl 5 nonanol and 4 methyl 5 nonanone; the active of Ethyl-4-Methyl octanoate; the active of Methyl eugenol; the active blend of Methyl eugenol and Cuelure; the active of (E,E)-8,10-Dodecadien-1-ol; the active blend of (Z)-8-Dodecen-1-yl acetate, (E)-8-Dodecen-1-yl-acetate and (Z)-8-Dodecen-1-ol; the active, (1R)-cis-4,6,6-Trimethylbicyclo [3.1.1]hept-3-en-2-one; the active Thrips; the active Bloom; the active Noctovi; the blend of Z-13-Octadecynyl acetate and Z-13-Octadecenol; the blend of (E,E)-10,12-hexadecadienal, (E,E)-10,12-hexadecadienol and E-10-hexadecenal; the blend of Z,E-9,12-Tetradecadien-1-yl-Acetate and Z-9 Tetradecenol; the blend of (Z)-8-Dodecen-1-yl acetate and (E)-8-Dodecen-1-yl-acetate; the active, (7E,9Z) dodeca-7,9-dien-1-yl acetate and the active 4-vinyl Anisole.

In an embodiment, the mesoporous materials are selected from the group consisting of Carbon Glucospheres, Magnesium Aluminometasilicate (Neusilin US2), and mesoporous silica (SBA15/Syloid 244P). The mesoporous materials can be used as intra-granular as well as extra-granular carriers in the preparation of solid formulations of the present invention.

In an embodiment, the matrix forming agent comprises emulsifying agents selected from the group consisting of Glyceryl behanate (Compritol 888), Polyoxyethylene Sorbitan Monolaurate (Tween 20) and Polyoxyethylene sorbitan monooleate (Tween 80), etc.

The binder is selected from the group consisting of Hydroxy propyl cellulose, HPMC & povidone, Glyceryl behenate or Ethyl cellulose. The lubricant is selected from stearic acid or magnesium stearate, Zinc stearate, calcium stearate.

The solid formulations of the present invention optionally comprise an anti-oxidant such as butylated hydroxyl toluene (BHT) and butylated hydroxy anisole (BHA) and a filler which is selected from dicalcium phosphate, MCC, Lactose. Starch or mannitol.

According to another embodiment, the solid pheromone formulation(s) are optionally comprising polymeric materials used as control release polymer and/or film coating control release polymer and/or hydrophobic polymer.

The polymeric materials are selected from the group consisting of;
a) SC3001 (make M/s Harind Chemicals and Pharmaceuticals Pvt Ltd), a specific ratio of Methyl MethAcrylates and 2-Hydroxy Ethyl Acrylates;
b) Seppic LM LP-030 (Seppic make) HPMC, Stearic acid, Magnesium Stearate in specific ratio and
c) EC (Ethyl Cellulose) dispersions (Ashland make) combination of Ethyl Cellulose, Cetyl Alcohol in specific ratio thereof.

In yet another embodiment, the present invention provides a process for preparation of the solid compositions which process comprises;
a) preparing a premix consisting of pheromone (active ingredient) in an amount of 0.5 to 60% adsorbed onto an adsorbent ingredient selected from the group consisting of mesoporous material(s), matrix forming agent(s) or the combination of mesoporous material(s) and matrix forming agent(s) in an amount of 1 to 50%;
b) blending with extra-granular ingredients in an amount of 75 to 85% consisting of mesoporous material, emulsifying agent, binder and lubricant followed by lubricating the blend; and
c) compacting the lubricated blend into a into a solid formulation.

The above said process according to the present invention optionally comprises a step of using polymeric materials either utilized as an external coating polymer for control release of active and/or as a film coating polymer for control release of active and/or used as hydrophobic polymer.

The process provided in the present invention is simple to carry out on industrial scale as the same can be performed under ambient temperature and pressure conditions.

In one embodiment, the formulation is optionally multi-layered in the form of tablets, minitablets, polo type tablets, or biconvex tablets with or without score line.

In another preferred embodiment, the formulation is optionally coated in the form of tablets, minitablets, polo type tablets, or biconvex tablets with or without score line.

The active pheromone according to preferred embodiments are selected from the group consisting of Z-8, Dodecynyl acetate, Methyl eugenol, Cuelure, Z 9-Tetradecenyl acetate, Z-11-Hexadecenal, Z-11-Hexadecenyl-1-acetate, (Z, Z/E)-7, 11-hexadecadien-1-yl acetate, (1R)-cis-4,6,6-Trimethylbicyclo hept-3-en-2-one, Spiroketal, (7E,9Z) dodeca-7,9-dien-1-yl acetate, E-11-hexadecen-1-yl acetate and (E)-11-hexadecen-1-ol, 3E,8Z,11Z-Tetradecatrienyl acetate and 3E,8Z-Tetradecadienyl acetate that are optionally used as blends or individually.

In an embodiment, the invention is demonstrated with various pheromones such as PBW active ingredient, Helicoverpa active ingredient, TUTA active ingredient, RHINO active ingredient, FAW active ingredient, Cuelure active ingredient and SPODO active ingredient as provided in examples 1 to 7. In another embodiment, the invention is demonstrated with active pheromone Z-8, Dodecynyl acetate, as provided in examples 8 to 13.

Accordingly, in one embodiment, the solid formulations of PBW active ingredient was prepared by dissolving the PBW active ingredient in dichloromethane and added BHT to it. This solution was adsorbed on Magnesium Aluminometasilicate (Neusilin US2) by evaporating the DCM solvent to obtain a premix of pheromone. The premix was then sieved through #50 mesh and blended with extra granular Magnesium Aluminometasilicate (Neusilin), Compritol 888 and DCP. Further, the blend was lubricated with magnesium stearate and then compacted to form a circular tablet using tablet punching machine equipped with circular tablet die. This tablet was coated with 1.5% of Polyacrylate modified with some hydrophobes/Stearic acid/HPMC.

In another embodiment, the solid formulations of Helicoverpa active ingredient was prepared by dissolving the Helicoverpa active ingredient in dichloromethane and added BHT to it. The solvent was evaporated to obtain a premix of pheromone. The premix was then sieved through #50 mesh and blended with extra granular Magnesium Aluminometasilicate (Neusilin), Compritol 888 and DCP. Further, the blend was lubricated with magnesium stearate and then compacted to form a circular tablet using tablet punching machine equipped with circular tablet die. This tablet was coated with 1.5% of SC300.

In another embodiment, the solid formulations of TUTA active ingredient (AI) was prepared by dissolving TUTA with DCM (Dichloromethane) and BHT (butylated hydroxytoluene). Subsequently DCM was flashed out at 50 °C to obtain a premix of pheromone. The premix was then sieved through #50 mesh and blended with extra granular Neusilin, Compritol 888 and DCPD (Diabasic Calcium phosphate dehydrate). The blend thus obtained was lubricated with magnesium stearate and then compacted to form a circular tablet/mini tablet using suitable tablet punching machine equipped with circular tablet die. This tablet was coated with 1.5% of Polyacrylate modified with some hydrophobes/Stearic acid/HPMC.

In a further embodiment, the solid formulations of RHINO active ingredient (AI) was prepared by dissolving RHINO active ingredient with DCM (Dichloromethane) and BHT (butylated hydroxytoluene). Subsequently DCM was flashed out at 50 °C to obtain a premix of pheromone. The premix was then sieved through #50 mesh and blended with extra granular Neusilin, Compritol 888 and DCPD (Diabasic Calcium phosphate dehydrate). The blend thus obtained was lubricated with magnesium stearate and then compacted to form a circular tablet/mini tablet using suitable tablet punching machine equipped with circular tablet die. This tablet was coated with 1.5% of Polyacrylate modified with some hydrophobes/Stearic acid/HPMC.

In yet another embodiment, the solid formulations of FAW active ingredient was prepared by adding Neusilin US2 to FAW active ingredient (AI) dissolved with DCM (Dichloromethane) and BHT (butylated hydroxytoluene). Subsequently DCM was flashed out at 50 °C and the premix thus obtained was then sieved through #50 mesh and blended with extra granular Neusilin, Compritol 888 and DCPD (Diabasic Calcium phosphate dehydrate). The blend thus obtained was lubricated with magnesium stearate and then compacted to form a circular tablet/mini tablet using suitable tablet punching machine equipped with circular tablet die. This tablet was coated with 1.5% of Polyacrylate modified with some hydrophobes/Stearic acid/HPMC.

In yet another embodiment, the solid formulations of Cuelure active ingredient was prepared by adding Neusilin US2 to Cuelure active ingredient (AI) dissolved with DCM (Dichloromethane) and BHT (butylated hydroxytoluene). Subsequently DCM was flashed out at 50 °C and the premix thus obtained was then sieved through #50 mesh and blended with extra granular Neusilin, Compritol 888 and DCPD (Diabasic Calcium phosphate dehydrate). The blend thus obtained was lubricated with magnesium stearate and bind with Klucel ELF and then compacted to form a circular tablet/mini tablet using suitable tablet punching machine equipped with circular tablet die.

In a further embodiment, the solid formulations of SPODO active ingredient was prepared by adding Neusilin US2 to SPODO active ingredient (AI) dissolved with DCM (Dichloromethane) and BHT (butylated hydroxytoluene). Subsequently DCM was flashed out at 50 °C. The premix thus obtained was then sieved through #50 mesh and blended with extra granular Neusilin, Compritol 888 and DCPD (Diabasic Calcium phosphate dehydrate). The blend thus obtained was lubricated with magnesium stearate and then compacted to form a circular tablet/mini tablet using suitable tablet punching machine equipped with circular tablet die. This tablet was coated with 1.5% of Polyacrylate modified with some hydrophobes/Stearic acid/HPMC.

According to another embodiment, the solid formulations of Z-8, Dodecynyl acetate was prepared by dissolving the Z-8, Dodecynyl acetate in dichloromethane and added BHT to it. This solution was adsorbed on Magnesium Aluminometasilicate (Neusilin US2) by evaporating the DCM solvent to obtain a premix of pheromone. The premix was then sieved through #30 or #40 ASTM and blended with extra granular Magnesium Aluminometasilicate (Neusilin), Compritol 888 and DCP. Further, the blend was lubricated with magnesium stearate and then compacted to form a circular tablet using tablet punching machine equipped with circular tablet die.

According to yet another embodiment, the solid formulations of Z-8, Dodecynyl acetate was prepared by dissolving the Z-8, Dodecynyl acetate in dichloromethane (DCM) and added BHT to it. This solution was adsorbed on Magnesium Aluminometasilicate (Neusilin US2) by evaporating the DCM solvent to obtain a premix of pheromone. This premix was further quoted with Buildo(methyl methacrylate and other acrylate poly blend) solution (2:1) and dried at 60 °C. The premix was then sieved through #30 or #40 and blended with extra granular Magnesium Aluminometasilicate (Neusilin), Compritol 888 and DCP. Further, the blend was lubricated with magnesium stearate and then compacted to form a circular tablet using tablet punching machine equipped with circular tablet die.

In yet another embodiment, the solid formulations of Z-8, Dodecynyl acetate was prepared by homogenizing the solution of Z-8, Dodecynyl acetate, molten Compritol, and Tween 80 to obtain solid cake, which was then pulverized into a fine powder. The premix was then blended with extra granular Magnesium Aluminometasilicate (Neusilin), Compritol 888, DCP and further lubricated with magnesium stearate and then compacted to form a circular tablet using tablet punching machine equipped with circular tablet die.

In yet another embodiment, the solid formulations of Z-8, Dodecynyl acetate was prepared by dissolving the Z-8. Dodecynyl acetate in Compritol in DCM to obtain a dispersion. This dispersion was then adsorbed onto Neusilin. The resultant powder was then blended with extra granular Neusilin, Compritol 888 and DCP and further lubricated with magnesium stearate and then compacted to form a circular tablet using tablet punching machine equipped with circular tablet die.

In yet another embodiment, the solid formulations of Z-8, Dodecynyl acetate was prepared by adsorbing the Z-8, Dodecynyl acetate onto activated carbon and then coated with molten Compritol with vigorous stirring and further milled to obtain a fine powder. This powder was subsequently blended with Neusilin, Compritol 888 and DCP. Hydroxy propyl cellulose (Klucel) was added to improve binding. Finally, the blend was lubricated with magnesium stearate and compacted to form a circular tablet using tablet punching machine equipped with circular tablet die.

In yet another embodiment, the solid formulations of Z-8, Dodecynyl acetate was prepared by adsorbing the solution of the active (in DCM) onto Syloid (Mesoporous Silica) and dried to remove solvent to obtain the premix. This premix was subsequently blended with Neusilin, Compritol 888, DCP and further lubricated with magnesium stearate and compacted to form a circular tablet using tablet punching machine equipped with circular tablet die.

In yet another embodiment, the tablet or mini tablet formulations of the present invention provides continued and sustained release of the active into the air over a period of 50 to 100 days or more.

The tablets and mini tablets formulations of the present invention capable of gradually releasing a pheromone substance into the air suitable for insect pest control over a long period of time and can be easily placed/distributed/dispersed on soil of a farm field or can be sprayed on the plants by dissolving in suitable medium and can be stored up to two years under normal storage conditions.

Pheromones are used as a pest management tool for detection, monitoring, plan pesticide spray programmes, mass trapping and mating disruption. In this context, ample literature is available on the pheromone formulations. However, research on pheromones as a tablet formulation for pest management is limited. Although, conventional pheromone traps, lures confer pest control, it requires frequent change of lures, effective design of trap and procurement cost is exorbitant (Cork et al., 2004a). Lack of proper knowledge on identification and synthesis of pheromones, designing the right type of formulation, amount of pheromone load for sustained release are the factors contributing to emphasise the present invention to be a proven approach for effective and eco-friendly pest management solution.

Consequently, there has been an increase in demand for controlled release pheromone formulations which are adapted to allow the pheromone substance to be released continuously and sustainably into air thereby encouraging mating disruption and thus reduces the damage to the crops. Furthermore, considering the small-scale farmers and economic feasibility, present invention emphasized on Tablet formulation to ease the application, sustain rainfrost, and season long release for effective pest management to increase the crop productivity and reduce the inimical pesticide toxicity on ecosystem.

PBW, Pink Bollworm (Pectinophora gossypiella, Lepidoptera) is a major pest in cotton and its infestation causes locule damage of 37.5% and 13.58% on non-Bt and Bt cotton respectively, at about 160 days of planting. Recently the pink bollworm strain developed 300-fold resistance to Bt cotton and still a challenging pest for cotton growers. Gossyplure and PB rope are the existing pheromone-based solutions and used as IPM tool to monitor the population. However, present invention caters the need for season long pheromone release and disrupts the mating to suppress the pest population. These mesoporous solid dispensers are effective and are tolerant to rain frost which is an added advantage.

Helicoverpa armigera. Corn ear worm a major pest in cotton, several vegetable and leguminous crops. Several chemical and integrated pest management measures are implemented to curtail the pest damage. However, it developed resistance to insecticides and GM crops posing a challenge to research community. Considering this loophole, semiochemical based solid dispenser is developed as an emerging novel tool to tailor the pest incidence. Below sample demonstrates the development of Helicoverpa tablets and AI release evaluation studies.

Rhinoceros beetle is a major threat in coconut palm causing huge loss to growers. Several aggregation pheromones in the form of lures are used to control the pest. With increasing dose, captures of Oryctes rhinoceros increased, but doses of 6, 9, and 18 mg/day were competitive with 30 mg/day lures. Food baited traps requires frequent service, its costly and is labour intensive. So, to combat the beetle, RHINO C-TAB and RHINO TAB PLUS a slow-release formulation containing the aggregation pheromone, ethyl 4-methyloctanoate in several dosage forms, 100 mg, 200 mg and 400 mg A.I in 500 mg and 1200 mg tablet dispensers is developed.

Fall armyworm (FAW), Spodoptera frugiperda (J. E. Smith) is a native pest in the tropical regions of the United States and is considered as a major threat to Corn growers across the globe causing yield losses ranging from 8.3 to 20.6 million tonnes per annum in Africa (Abrahams et al., 2017; Day et al., 2017). FAW developed resistance to insecticides and Bt corn in Brazil. In spite of, several chemical and cultural practice, control of FAW is challenging. Two applications of SPLAT FAW achieved a trap shutdown rate of up to 100% over the course of field trials in Brazil and significant damage reduction of corn ears of up to 15%. The addition of an additional application of NOCTOVI allowed to effectively reduce the effect of the migratory gravid females to the field. Several grants were registered for SPLAT FAW trials. Furthermore, using this domain knowledge, FAW tablet formulation is developed to target wide geography.

Spodoptera litura, tobacco cutworm a polyphagous pest worldwide which developed resistance to multiple insecticides, integration of different control practices, especially the rotation of insecticides with biocontrol agents, pheromone lures are the possible control measures. Due to high fecundity, serval alternate hosts and insecticide resistance there is intense need for eco-friendly and effective control measure. SPODO Tablet formulations are evaluated in the present invention to commensurate the inimical effects of chemicals and sustained pest control.

Cuelure a semiochemical formulation for suppression of Bactrocera cucurbitae a major pest of cucurbits. Use of SPLAT (Specialized Pheromone and Lure Application Technology) Male Annihilation Treatment (MAT) containing either ME or C-L (Leblanc et al., 2011) is the novel IPM tool for management of fruit fly. CREMIT & MANTRA are the Series marks for branding the above said formulations. The products of the present invention works under Rain and is effective for 3 months as compared to conventional pheromone traps and lures which needs frequent servicing and replacement of fresh lures periodically.

List of pheromones and its abbreviated forms disclosed herein:

| Brand Name | Active Blend |
|---|---|
| PBW | (Z,Z)-7,11-hexadecadien-1-yl acetate |
| | (Z,E)-7,11-hexadecadien-1-yl acetate |
| FAW | Z9-Tetradecenyl acetate |
| | Z7-Dodecenyl acetate |
| | Z11-Hexadecenyl acetate |
| BFSB | E-11-hexadecen-1-yl acetate |
| | (E)-11-hexadecen-1-ol |
| TUTA | 3E,8Z,11Z-Tetradecatrienyl acetate |
| | 3E,8Z-Tetradecadienyl acetate |
| CLM | (Z,Z,E)-7,11,13-Hexadeca trien-1-al |
| DBM | Z-11-Hexadecenal |
| | Z-11-Hexadecenyl-1-acetate |
| | Z-11-Hexadecenol |
| YSB | Z-11-Hexadecenal |
| | Z-9-Hexadecenal |
| Helico | Z-11-Hexadecenal |
| | Z-9-Hexadecenal |
| Spodo | (Z,E)-9,11-Tetradecadienyl acetate |
| | Z9,E-12-Tetradecadienyl acetate |
| TMB | Cis-3-Hexenyl acetate |
| | 2E-Hexen-1-ol |
| PSB | Z-11-Hexadecenyl-1-acetate |
| | Z-11-Hexadecenol |
| ESB | Z-11-Hexadecenol |
| EC | (7Z,9E)-Dodeca-7,9,11-trien-1-yl formate (Carob |
| | moth) |
| NOW | 11Z,13Z-Hexadeca dienal |
| RPW | 4 methyl 5 nonanol |
| | 4 methyl 5 nonanone |
| Rhino | Ethyl-4-Methyl octanoate |
| ME | Methyl eugenol |
| ME/CL | Methyl eugenol |
| | Cuelure |
| CM | (E,E)-8,10-Dodecadien-1-ol |
| OFM | (Z)-8-Dodecen-1-yl acetate |
| | (E)-8-Dodecen-1-yl-acetate |
| | (Z)-8-Dodecen-1-ol |
| PB | (1R)-cis-4,6,6-Trimethylbicyclo [3.1.1]hept-3-en- |
| | 2-one |
| WFT | Thrips |
| Profuze | Bloom |
| Noktowich | Noctovi |
| ISB | Z-13-Octadecynyl acetate |
| | Z-13-Octadecenol |
| LPB | (E,E)-10,12-hexadecadienal |
| | (E,E)-10,12-hexadecadienol |
| | E-10-hexadecenal |
| SE | Z,E-9,12-Tetradecadien-1-yl-Acetate |
| | Z-9 Tetradecenol |
| FCM | (Z)-8-Dodecen-1-yl acetate |
| | (E)-8-Dodecen-1-yl-acetate |
| Lobesia | 7E,9Z Dodecadienyl acetate |

The following examples, which include preferred embodiments, will serve to illustrate the practice of this invention, it being understood that the particulars shown are by way of example and for purpose of illustrative discussion of preferred embodiments of the invention.

Below are the illustrations for evaluation of active ingredient release from solid dispensers with coated and noncoated tablets for management of various target pests which are contributing to economic yield loss.

### DESCRIPTION OF FIGURES

FIG. 1: AI retention percent in coated (1a) and uncoated (1b) PBW tablet

FIG. 2: AI retention percent in coated (2a) and uncoated (2b) Helico tablet

FIG. 3: AI retention percent in coated (3a) and uncoated (3b) TUTA tablet

FIG. 4: AI retention percent in coated (4a) and uncoated (4b) RHINO tablet

FIG. 5: AI retention percent in FAW tablet

FIG. 6: AI retention percent in Cuelure tablet

FIG. 7: AI retention percent in Z-8 Dodecenyl acetate coated tablets

FIG. 8: AI retention percent in ME coated tablet

FIG. 9: AI retention percent in SPODO coated tablet

FIG. 10: AI retention percent of ME, Cuelure, PBW, FAW. Helico and Tuta of coated tablets

### EXAMPLE 1

20 mg of Neusilin US2 was weighed. To this, 8 mg of PBW active ingredient (AI) dissolved with 250 ml of DCM (Dichloromethane) and 0.08 mg of BHT (butylated hydroxytoluene) were added. Subsequently DCM was flashed out at 50 °C. The premix was then sieved through #50 mesh and blended with 100 g extra granular Neusilin, 50 g Compritol 888 and 317 mg DCPD (Diabasic Calcium phosphate dehydrate). The blend thus obtained was lubricated with 5 mg magnesium stearate and then compacted to form a circular tablet/mini tablet using suitable tablet punching machine equipped with circular tablet die. This tablet is coated with 1.5% of Polyacrylate modified with some hydrophobes/Stearic acid/HPMC.

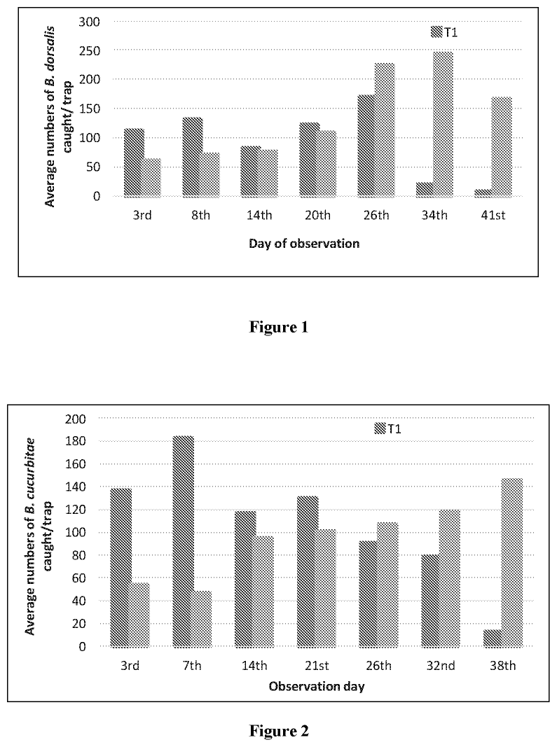

AI retention percent results from present invention indicates that 86% of PBW AI is retained by loading 8 mg/tablet after 21 days irrespective of coating, while the Control release is expected up to 150 days for both coated and uncoated tablet formulation for effective control of Pink Bollworm (PBW). 8 mg of PBW AI is loaded per tablet wherein AI is retained after 21st day is highest among other AI (FIG. 1).

### EXAMPLE 2

10 mg of Neusilin US2 was weighed. To this, 5 mg of Helicoverpa active ingredient (AI) dissolved with 10 ml of DCM (Dichloromethane) and 0.05 mg of BHT (butylated hydroxytoluene) were added. Subsequently DCM was flashed out at 50 °C. The premix was then sieved through #50 mesh and blended with 100 g extra granular Neusilin, 50 g Compritol 888 and 330 mg DCPD (Diabasic Calcium phosphate dehydrate). The blend thus obtained was lubricated with 5 mg magnesium stearate and then compacted to form a circular tablet/mini tablet using suitable tablet punching machine equipped with circular tablet die. This tablet is coated with 1.5% of SC300.

For management of Helicoverpa armigera, 5 mg of Helio AI is loaded per tablet wherein AI retained after 21st day is 80% with coated tablets while expected control release lasts up to 105 days for coated tablets. However, uncoated tablet showed slightly higher retention of AI ie. 90% than coated tablet. Loss of AI during the coating is non-significant (FIG. 2).

### EXAMPLE 3

Tomato pinworm Tuta absoluta a major pest in tomato can be effectively controlled using TUTA tablets. 10 mg of Neusilin US2 was weighed. To this, 5 mg of TUTA active ingredient (AI) dissolved with 10 ml of DCM (Dichloromethane) and 0.05 mg of BHT (butylated hydroxytoluene) were added. Subsequently DCM was flashed out at 50 °C. The premix was then sieved through #50 mesh and blended with 100 mg extra granular Neusilin, 50 g Compritol 888 and 330 mg DCPD (Diabasic Calcium phosphate dehydrate). The blend thus obtained was lubricated with 5 mg magnesium stearate and then compacted to form a circular tablet/mini tablet using suitable tablet punching machine equipped with circular tablet die. This tablet is coated with 1.5% of Polyacrylate modified with some hydrophobes/Stearic acid/HPMC.

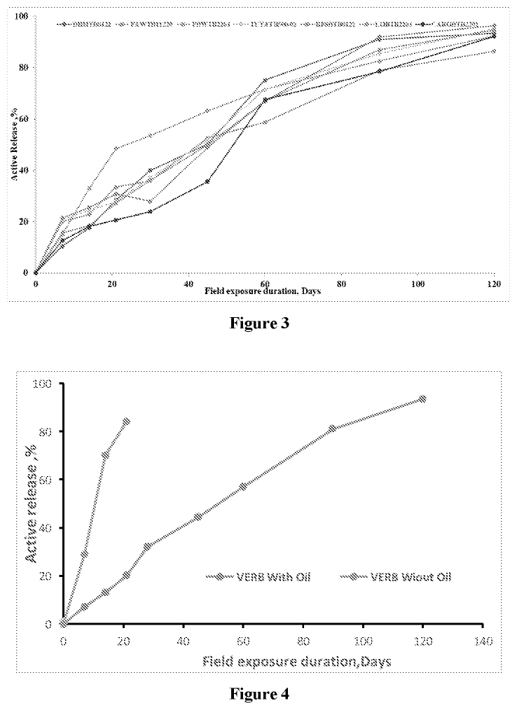

For active release studies, 5 mg of TUTA AI is loaded per tablet where 77% of AI was retained after 21st day in coated tablets while expected control release up to 90 days for coated tablets. However, Uncoated tablet showed slightly lower retention of AI ie. 62% after 21 days than coated tablet. 32% of AI is dissipated during coating (FIG. 3).

### EXAMPLE 4

200 mg of Neusilin US2 was weighed. To this, 200 mg of RHINO active ingredient (AI) dissolved with 200 ml of DCM (Dichloromethane) and 2 mg of BHT (butylated hydroxytoluene) were added. Subsequently DCM was flashed out at 50 °C. The premix was then sieved through #50 mesh and blended with 50 mg extra granular Neusilin, 100 mg Compritol 888 and 440 mg DCPD (Diabasic Calcium phosphate dehydrate). The blend thus obtained was lubricated with 10 mg magnesium stearate and then compacted to form a circular tablet/mini tablet using suitable tablet punching machine equipped with circular tablet die. This tablet is coated with 1.5% of Polyacrylate modified with some hydrophobes/Stearic acid/HPMC.

In present study, 200 mg of RHINO AI is loaded per tablet wherein the AI remaining drastically reduced to 5% after 21 days from coated tablets due to low vapour pressure and thus leading to higher release rate of the active (FIG. 4).

### EXAMPLE 5

20 mg of Neusilin US2 was weighed. To this, 8 mg of FAW active ingredient (AI) dissolved with 20 ml of DCM (Dichloromethane) and 0.08 mg of BHT (butylated hydroxytoluene) were added. Subsequently DCM was flashed out at 50 °C. The premix was then sieved through #50 mesh and blended with 100 g extra granular Neusilin, 50 g Compritol 888 and 317 mg DCPD (Diabasic Calcium phosphate dehydrate). The blend thus obtained was lubricated with 5 mg magnesium stearate and then compacted to form a circular tablet/mini tablet using suitable tablet punching machine equipped with circular tablet die. This tablet is coated with 1.5% of Polyacrylate modified with some hydrophobes/Stearic acid/HPMC.

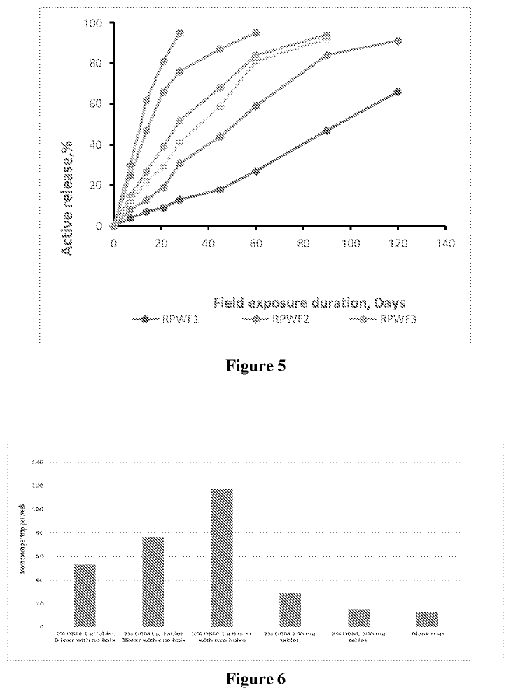

In present invention, FAW tablet is evaluated with 18 mg of AI load per tablet to understand the pheromone retention which accounted to 60% after 21 days of application while expected control release is estimated to 60% after 21 days (FIG. 5).

### EXAMPLE 6

250 mg of Neusilin US2 was weighed. To this, 300 mg of Cuelure active ingredient (AI) dissolved with 200 ml of DCM (Dichloromethane) and 3 mg of BHT (butylated hydroxytoluene) were added. Subsequently DCM was flashed out at 50 °C. The premix was then sieved through #50 mesh and blended with 100 mg extra granular Neusilin, 50 mg Compritol 888 and 275 mg DCPD (Diabasic Calcium phosphate dehydrate). The blend thus obtained was lubricated with 10 mg magnesium stearate and bind with 15 mg Klucel ELF and then compacted to form a circular tablet/mini tablet using suitable tablet punching machine equipped with circular tablet die.

Cuelure tablet is evaluated with 300 mg of AI load per tablet wherein AI retained after 21st day is 65% while expected control release up to 80 days (FIG. 6).

### EXAMPLE 7

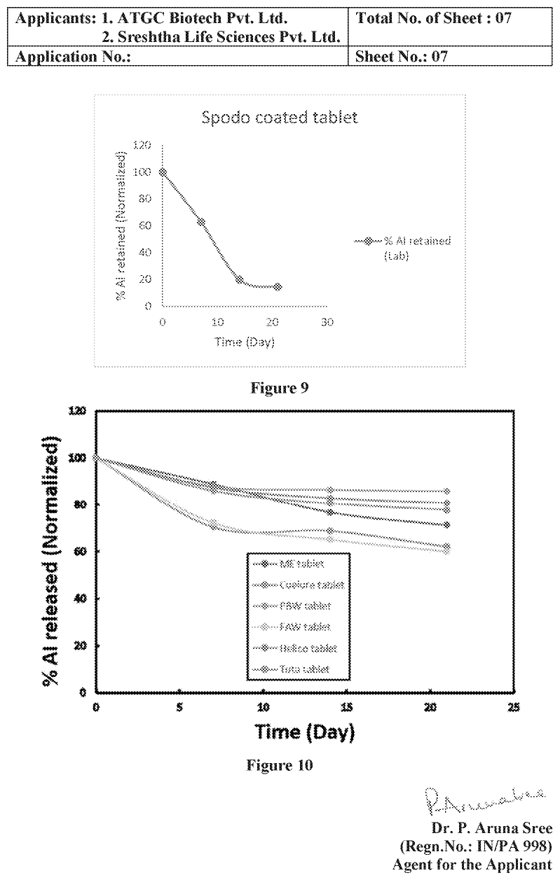

20 mg of Neusilin US2 was weighed. To this, 8 mg of SPODO active ingredient (AI) dissolved with 20 ml of DCM (Dichloromethane) and 0.08 mg of BHT (butylated hydroxytoluene) were added. Subsequently DCM was flashed out at 50 °C. The premix was then sieved through #50 mesh and blended with 100 mg extra granular Neusilin, 50 mg Compritol 888 and 317 mg DCPD (Diabasic Calcium phosphate dehydrate). The blend thus obtained was lubricated with 5 mg magnesium stearate and then compacted to form a circular tablet/mini tablet using suitable tablet punching machine equipped with circular tablet die. This tablet is coated with 1.5% of Polyacrylate modified with some hydrophobes/Stearic acid/HPMC. The AI retention studies shows 15% was retained in 21 days. The release profile is shown in FIG. 9.

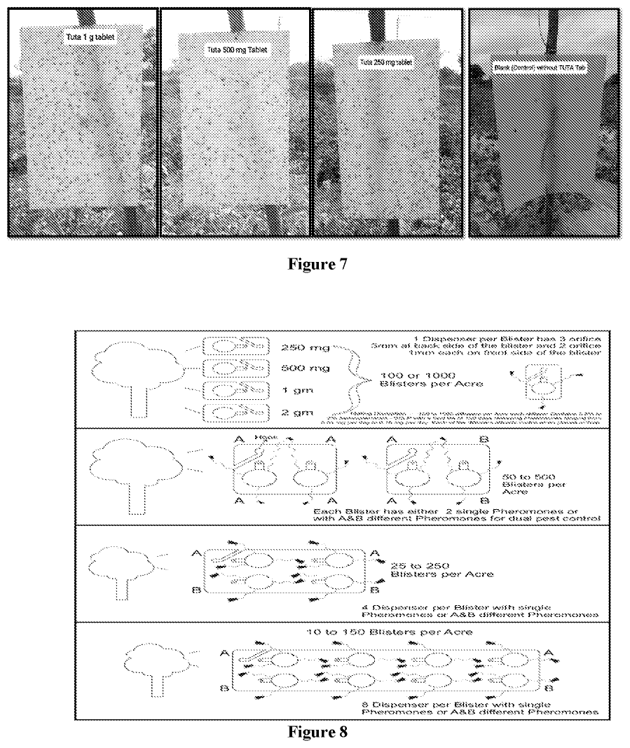

In another experiment, AI retention studies in Z-8 Dodecenyl acetate indicates that percent of AI is high up to 80% till 21 days after release and it gradually declines to 50% after 6 weeks of application. AI of 300 mg is loaded per tablet which accounted to retain 65% of AI after 21 days while control release was up to 80 days under lab conditions (FIG. 7).

Likewise, 300 mg of ME AI per tablet is loaded to test the release rate and efficacy against fruit flies, 75% of AI is retained after 21st day while Expected control release is estimated up to 90 days (FIG. 8).

Additionally, various formulations in tablet/mini tablet forms with mesoporous materials containing Z-8, Dodecynyl acetate as active ingredient (AI), were prepared as shown in below table 1.

TABLE 1

| | | | | | | |
|---|---|---|---|---|---|---|
| Component | F-1 | F-2 | F-3 | F-4 | F-5 | F-6 |

Premix formulation

| Z-8, Dodecynyl acetate | 6 | g | 6 | g | 6 | g | 8 | g | 6 | g | 6 | g |
|---|---|---|---|---|---|---|---|---|---|---|---|---|
| Neusilin US2 | 14 | g | 14 | g | — | | 50 | g | — | | — | |
| Activated carbon | — | | — | | — | | — | | 14 | g | — | |
| Mesoporous silica | — | | — | | — | | | | — | | 7 | g |
| Compritol | — | | — | | 14 | g | 14 | g | — | | — | |
| Tween 80 | — | | — | | 2 | g | — | | — | | — | |
| BHT | 60 | mg | 60 | mg | | | | | | | | |

Extra granular ingredients

| Neusilin US2 | 100 | g | 100 | g | 100 | g | 50 | g | 100 | g | 100 | g |
|---|---|---|---|---|---|---|---|---|---|---|---|---|
| Compritol 888 | 50 | g | 50 | g | 36 | g | 36 | g | 22 | g | 50 | g |
| DCP | 325 | g | 311 | g | 339 | g | 325 | g | 315 | g | 325 | g |
| Magnesium stearate | 5 | g | 5 | g | 5 | g | 5 | g | 5 | g | 5 | g |
| Klucel | — | | — | | — | | — | | 10 | g | — | |
| total | 500.6 | gm | 486.6 | gm | 502 | gm | 488 | gm | 472 | g | 493 | gm |

The process for preparation of F-1 to F-6 formulations using Z-8, Dodecynyl acetate, as active ingredient is described in the following examples.

The solid formulations disclosed herein are stable and can be stored up to two years under normal storage conditions.

### EXAMPLE 8

14 g of Neusilin US2 was weighed. To this, 6 g of active ingredient (AI) diluted with 250 ml of DCM (Dichloromethane) and 60 mg of BHT (butylated hydroxytoluene) were added. Subsequently DCM was flashed out at 50 °C. The premix was then sieved through #40 ASTM and blended with 100 g extra granular Neusilin, 50 g Compritol 888 and 325 g DCP. The blend thus obtained was lubricated with 5 g magnesium stearate and then compacted to form a circular tablet/mini tablet using suitable tablet punching machine equipped with circular tablet die.

### EXAMPLE 9

14 g of Neusilin US2 was weighed. To this, 6 g of AI diluted with 250 ml of DCM (Dichloromethane) and 60 mg of BHT (butylated hydroxytoluene) were added. 14 g Buildo (methyl methacrylate and other acrylate poly blend solution (2:1)) was added to coat the powder, and dried at 60 °C. The premix was then sieved through #40 blended with 100 g extra granular Neusilin, 50 g Compritol 888 and 311 g DCP.

The blend thus obtained was finally lubricated with 5 g magnesium stearate and then compacted to form a circular tablet using tablet punching machine equipped with circular tablet die.

### EXAMPLE 10

To a 14 g of molten Compritol, 6 g AI and 2 g Tween 80 solution were added and homogenized, to obtain solid cake which was then pulverized into a fine powder. The polymer coated premix This powder was then blended with 100 g Neusilin, 36 g Compritol 888, 339 g DCP and further lubricated with 5 g magnesium stearate and then compacted to form a circular tablet using tablet punching machine equipped with circular tablet die.

### EXAMPLE 11

8 g AI was dissolved to a 14 g of 6 wt % Compritol in DCM. This dispersion was then adsorbed to 50 g Neusilin. The resultant powder was then blended with 50 g extra granular Neusilin, 36 g Compritol 888, 325 g DCP. Lubricated with 5 g magnesium stearate and then compacted to form a circular tablet using tablet punching machine equipped with circular tablet die.

### EXAMPLE 12

6 g of AI was adsorbed in 14 g of activated carbon. The active adsorbed on carbon was then coated with molten Compritol with vigorous stirring. The wax coated active adsorbed on carbon was milled to a fine powder. This powder was subsequently blended with 100 g Neusilin, 22 g Compritol 888, 315 g DCP. 10 g Klucel was added to improve binding. Finally, the blend was lubricated with 5 g magnesium stearate and compacted to form a circular tablet using tablet punching machine equipped with circular tablet die.

### EXAMPLE 13

6 g of AI in DCM was adsorbed in 7 g of Syloid (Mesoporous Silica) and dried to remove solvent to obtain premix. This premix was subsequently blended with 100 g Neusilin, 50 g Compritol 888, 325 g DCP and the blend thus obtained was lubricated with 5 g magnesium stearate and compacted to form a circular tablet using tablet punching machine equipped with circular tablet die.

I claim:

1. A sustained release solid tablet semiochemical/s dispenser comprises,
a) an intra-granular premix consisting of semiochemical/s insect sex pheromone or allomone or kairomone, in an amount of 0.5 to 40% w/w in combination with antioxidant and low-cost release controlling agent, adsorbed onto an adsorbent combination of mesoporous and matrix forming materials in an amount of 1 to 50% w/w of total composition;
b) extra-granular ingredients consisting of mesoporous material, filler, and binder, in an amount of 50 to 85% w/w of total composition.
c) intra-granular premix a) and extra granular part b) mixed and lubricated with metallic stearates up to 1% w/w of total composition;
d) Lubricated blend compressed in the form of double convex solid tablet or polo type tablets with variable target weights;
Wherein solid semiochemical dispenser showed sustained release of Semiochemicals in an open environment for at least twelve weeks and used for insect management by either mating disruption or mass trapping-control technique. Some are capable for releasing semiochemical even when submerged in water without disintegration and showed rain fast property.

2. The solid semiochemical dispenser as claimed in claim 1, the release controlling agent selected from mixture of vegetable oil and synthetic oil in specific ratio wherein vegetable oils further selected form the group comprising soybean oil, rice bran oil, cotton seed oil, olive oil, castor oil, jojoba oil, oleic acid, safflower oil, corn oil, peanut oil, sesame oil, castor oil, medium chain triglycerides, Isopropyl palmitate, and synthetic oils selected from mineral or paraffin oils, most preferably a mixture of soyabean and paraffin oil;

3. The solid semiochemical dispenser as claimed in claim 2, the ratio of paraffin oil to soyabean oil selected from 1:1 to 4:1 w/w for sustained and prolonged release of Semiochemicals;

4. The solid semiochemical dispenser as claimed in claim 1, straight-chained lepidopteran sex pheromones selected in the formulations according to the present invention from the group not limited to the active blend of (Z, Z)-7, 11-hexadecadien-1-yl acetate and (Z, E)-7, 11-hexadecadien-1-yl acetate; the active blend of Z 9-Tetradecenyl acetate, Z7-Dodecenyl acetate and 15 Z11-Hexadecenyl acetate; the active blend of E-11-hexadecen-1-yl acetate and (E)-11-hexadecen-1-ol; the active blend of 3E,8Z,11Z-Tetradecatrienyl acetate and 3E,8Z-Tetradecadienyl acetate; the active, (Z,Z,E)-7,11,13-Hexadeca trien-1-al; the active blend of Z-11-Hexadecenal, Z-11-Hexadecenyl-1-acetate and Z-11-Hexadecenol; the active blend of Z-11-Hexadecenal and Z-9-Hexadecenal; the 20 active blend of Z-11-Hexadecenal and Z-9-Hexadecenal; the active blend of (Z,E)-9,11-Tetradecadienyl acetate and Z9,E-12-Tetradecadienyl acetate; the active blend of Cis-3-Hexenyl acetate and 2E-Hexen-1-ol; the active blend of Z-11-Hexadecenyl-1-acetate and Z-11-Hexadecenol; the active of Z-11-Hexadecenol; the active of (7Z,9E)-Dodeca-7,9,11-trien-1-yl formate (Carob moth); 11Z,13Z25 Hexadeca dienal; the active blend of 4 methyl 5 nonanol and 4 methyl 5 nonanone; the active of Ethyl-4-Methyl octanoate; the active of Methyl eugenol; the active blend of Methyl eugenol and Cuelure; the active of (E,E)-8,10-Dodecadien-1-ol; the active blend of (Z)-8-Dodecen-1-yl acetate, (E)-8-Dodecen-1-yl-acetate and (Z)-8-Dodecen-1-ol; the active, (1R)-cis-4,6,6-Trimethylbicyclo [3.1.1]hept-3-en30 2-one; the active Thrips; the active Bloom; the active Noctovi; the blend of Z-13-Octadecynyl acetate and Z-13-Octadecenol; the blend of (E,E)-10,12-7 hexadecadienal, (E,E)-10,12-hexadecadienol and E-10-hexadecenal; the blend of Z,E-9,12-Tetradecadien-1-yl-Acetate and Z-9 Tetradecenol; the blend of (Z)-8-Dodecen-1-yl acetate and (E)-8-Dodecen-1-yl-acetate; the active, (7E,9Z) dodeca7,9-dien-1-yl acetate and the active 4-vinyl Anisole;

5. The solid semiochemical dispenser as claimed in claim 1, the attractant semiochemical selected from the group verbenone, RPW, Methyl eugenol, Cue lure, Trimedlure, Spiroketal or other attractant semiochemical either alone or a mixture thereof.

6. The solid semiochemical dispenser as claimed in claim 1, antioxidant selected either butylated hydroxyl toluene (BHT) or butylated hydroxy anisole (BHA) preferably butylated hydroxy toluene;

7. The solid semiochemical dispenser as claimed in claim 1, semiochemical adsorbent material selected from the group consisting of mesoporous materials with very narrow pore size preferably a mixture of mesoporous silica and carbon HBET, and used as intragranular as well as extra-granular carriers in the preparation of solid formulation;

8. The solid semiochemical dispenser as claimed in claim 1, Carbon HBET selected as UV absorbent in the present invention;

9. The solid semiochemical dispenser as claimed in claim 1, filler selected from the group dicalcium phosphate, microcrystalline cellulose, Lactose, Starch or mannitol preferably dicalcium phosphate.

10. The solid semiochemical dispenser as claimed in claim 1, binder selected from the group consisting of Hydroxy propyl cellulose, Hydroxy propyl methyl cellulose, Ethyl cellulose, poly (vinyl pyrrolidone co vinyl acetate), polyvinyl pyrrolidone either alone or in combination thereof.

11. The solid semiochemical dispenser as claimed in claim 1, lubricant selected from stearic acid, metallic stearate, magnesium stearate, Zinc stearate, calcium stearate preferably magnesium stearate.

12. The solid semiochemical dispenser as claimed in claim 1, the solid formulations are compressed in the form of double convex tablets, mini tablets, and Polo type tablets using tableting machine;

13. The solid semiochemical dispenser as claimed in claim 1, solid dispenser can be optionally film coated with available ready mix water dispersible coating system comprises water soluble polymers not limited to Hydroxy propyl methyl cellulose, hydroxy propyl cellulose, hydrophobically modified alkali swellable acrylates.

14. The solid semiochemical dispenser as claimed in claim 1, wherein the controlled release of embedded pheromones or Semiochemicals can be modulated from 30 days and 365 days.

15. The solid semiochemical dispenser as claimed in claim 1, some attractant verbenone, RPW, Methyl eugenol, Cue Lure, Spiroketal and RHY showed good active release even when submerged in water,

16. The solid semiochemical dispenser as claimed in claim 1, can be placed in McPhail traps or any sticky traps, water traps, and bucket traps for mass trapping or monitoring purposes;

17. The solid semiochemical dispenser as claimed in claim 1, in combination of conventional chemical insecticides can be placed in McPhail traps or any sticky traps, water traps, bucket traps for mass trapping control purposes;

18. The general method of preparation for the solid tablet semiochemical dispenser comprises following steps,
a) Pheromone or semiochemical in an amount 0.5 to 40% w/w of the total composition was dissolved in highly volatile organic solvent dichloromethane along with antioxidant in an amount 0.05 to 1% w/w of total composition, oil mixture 5 to 15% w/w of total composition (7:3 w/w of paraffin:soyabean oil);
b) an intragranular premix prepared by adsorbing Semiochemicals solution as prepared in step a) onto mixture of mesoporous materials and carbon glucosphere adsorbent present in an amount 1 to 30% w/w of total composition. Organic solvent was evaporated during drying up to 500 C.
c) The premix was then sieved through #30 to 50 mesh and blended with extra granular mesoporous material in an amount 20 to 30% w/w of total composition, binder 1 to 5% of total composition and Dibasic Calcium phosphate dihydrate (DCP) in an amount 10 to 65% w/w of total composition.
d) The blend thus obtained was lubricated with magnesium stearate in an amount up to 1% w/w of the total composition and then compacted to form a biconvex circular tablet/mini tablet using suitable tablet punching machine equipped with circular tablet die with variable target weight of 250 to 2000 mg per tablet.

19. The solid semiochemical dispenser as claimed in claim 1, wherein specifically verbenone semiochemical sustained at least up to 120 days duration despite comparatively very high volatility.

20. The solid semiochemical dispenser as claimed in claim 1, wherein the semiochemical composition formulated as a tablet can be stored in the form of blister pack units Alu-Alu blister and applied directly into agricultural field punctured with pin before application.

21. The solid semiochemical dispenser as claimed in claim 1, wherein it comprises active in the range of 5 mg to 600 mg active per unit and exhibits an average release rate as low as 0.02 mg per day to 5 mg per day.

22. The solid semiochemical dispenser as claimed in claim 1, wherein the solid tablet semiochemical/s dispenser exhibits average release rate from 0.02 mg per day to 0.2 mg per day for straight chain lepidopteran pheromones, and 5 mg per day for others attractive semiochemical/s.

23. The solid semiochemical dispenser as claimed in claim 1, the tablet can be fixed onto cloth or paper or the plant surface using an adhesive.
